(19) United States
(12) Patent Application Publication
(10) Pub. No.: US 2020/0107633 A1
(43) Pub. Date: Apr. 9, 2020

(54) LIFTING DESK

(71) Applicant: Ningbo Kangying Metal Product Co., LTD, Ningbo (CN)

(72) Inventor: Wei KANG, Ningbo (CN)

(21) Appl. No.: 16/170,996

(22) Filed: Oct. 25, 2018

(30) Foreign Application Priority Data
Oct. 8, 2018 (CN) 201811167847.3

(51) Int. Cl. A47B 23/04; A47B 21/02; A47B 21/04; A47B 9/16; A47B 23/06

(52) U.S. Cl. CPC A47B 23/04; A47B 21/02; H02J 7/025; A47B 9/16; A47B 23/06; A47B 21/04

(57) ABSTRACT

A lifting desk where one end of the bottom of a fork-type lifting frame is translationally hinged with one side portion of a base, and one end of the top of the lifting frame is translationally hinged with one side portion of a bottom surface of a desk board. The other end of the bottom of the fork-type lifting frame is hinged with the other side portion of the base via a pin, and the other end of the top of the lifting frame is hinged with the other side portion of the desk board via a pin. A driving device for controlling the rise or fall of the fork-type lifting frame is fixed on the base. The driving device is fixedly connected with a connecting rod.

### FIELD OF THE INVENTION

The invention relates to the technical field of supporting tablet personal computers, notebook computers, desktop computers and the like, and particularly to a lifting desk.

### BACKGROUND OF THE INVENTION

As daily necessities, desks are commonly used in life, work and school learning. A common desk generally consists of a desktop and legs which are fixedly connected, and the length of the legs is also fixed such that the height of the entire desktop is fixed and unadjustable. Moreover, a charging data line must be pulled out from a power plug and plugged into a mobile phone or a tablet personal computer for charging operation when the mobile phone or the tablet personal computer needs to be charged; it is inconvenient to answer an incoming call, make a phone call, and view and reply messages during charging due to the limited length of the charging data line; and the charging data line is easily entangled with other power lines, keyboard connecting lines or mouse connecting lines such that the desktop of the lifting desk is quite messy. However, with the different application environments as well as the application needs of different populations, higher and higher requirements are also placed on the height diversity, automation, comfort and convenience in use of desks. Accordingly, there is a need for a height-adjustable lifting desk.

### SUMMARY OF THE INVENTION

An object of the invention is to provide a lifting desk which is capable of raising or lowering a desk board and convenient to use so as to solve the above technical disadvantages.

The invention provides a lifting desk, which comprises a base, a desk board and a lifting mechanism mounted between the base and the desk board, wherein a wireless charging device is embedded in the desk board; the lifting mechanism comprises at least two lifting frames, respective one ends of the bottom of the at least two fork-type lifting frames are translationally hinged with one side portion of the base, and respective one ends of the top of the lifting frames are translationally hinged with one side portion of a bottom surface of the desk board; the other respective ends of the bottom of the at least two fork-type lifting frames are hinged with the other side portion of the base via pins, and the other respective ends of the top of the lifting frames are hinged with the other side portion of the desk board via pins; and the respective one ends of the bottom of the at least two fork-type lifting frames are connected to each other by a connecting rod, a driving device for controlling the rise or fall of the fork-type lifting frames is fixed on the base, and the driving device is fixedly connected with the connecting rod.

Further preferably, the lifting desk further comprises a keyboard supporting board, wherein a front side portion of the desk board is fixedly connected with the keyboard supporting board by an inclined connection board.

Further preferably, the inclined connection board is provided with a USB interface and a drawer slot, a drawer box is inserted into the drawer slot, a top edge of the drawer slot is fixedly connected with the bottom surface of the desk board, and a handle is arranged on a front side face of the drawer box.

Further preferably, the drawer slot is specifically configured as follows: a through hole is arranged at the top of the inclined connection board, and a decorative board is fixed on a front side face of the inclined connection board; a drawer slot body is arranged at the top of the decorative board, the drawer slot body penetrates through the through hole, an inner side face of the bottom of the drawer slot on the drawer slot body and a bottom side face in the drawer box are respectively recessed downward in the shape of an isosceles triangle to form an inwardly inclined recessed portion I, and an outer side face of the bottom of the drawer slot body forms an isosceles-triangle outer side face I which is identical to the recessed shape of an isosceles triangle after the fork-type lifting frames are fully unfolded; an outer side face of the bottom of the drawer box forms an isosceles-triangle outer side face II correspondingly matching the inwardly inclined recessed portion I; an inwardly inclined recessed portion II that matches the isosceles-triangle outer side face I in a fitting manner is arranged on a bottom side face of the through hole; and decorative stripes are respectively arranged on a front side face of the decorative board and a front side face of the drawer box.

Further preferably, an existing flange is arranged on a side edge of the front side face of the drawer box, an existing annular groove is arranged at a front-end opening of the drawer slot, and the flange is correspondingly inserted into the annular groove.

Further preferably, an anti-skid cushion is fixed on a top surface of the keyboard supporting board in a fitting manner.

Further preferably, respective one ends of the bottom of the at least two fork-type lifting frames are translationally hinged with one side portion of the base, and respective one ends of the top of the lifting frames are translationally hinged with one side portion of a bottom surface of the desk board; and the specific translational hinging is configured as follows: each of the at least two fork-type lifting frames comprises one supporting rod I and one supporting rod II which are hinged via pins after intersecting with each other, two tracks are respectively arranged on the bottom surface of the desk board and the base, and the tracks on the desk board are positioned correspondingly to the tracks on the base; translational grooves of the tracks are internally provided with translatable pulleys, bottom ends of the at least two supporting rods I are translationally hinged with the pulleys on the base via rotating shafts, and top ends of the supporting rods I are hinged with the bottom surface of the desk board via pins; top ends of the at least two supporting rods II are translationally hinged with the pulleys on the bottom surface of the desk board via rotating shafts, and bottom ends of the supporting rods II are hinged with a side portion of the base via pins; the bottom ends of the at least two supporting rods I are connected to each other by the connecting rod; and hinged points of the at least two supporting rods II are fixedly connected to each other by a cross bar.

Further preferably, a vertically penetrating mounting housing is fixed on the bottom surface of the desk board, and the two tracks on the desk board are respectively mounted and positioned on left and right inner side walls of the mounting housing.

Further preferably, a limit sensor is mounted on a side portion of the driving device, and a probe of the limit sensor is corresponding to the connecting rod.

Further preferably, a shield shell is covered above the driving device and at the side portion of the base, and the driving device is a linear lifting electric cylinder.

The lifting desk provided by the invention is configured such that the desk board can be raised or lowered by the lifting operation of the fork-type lifting frames, and the driving device can work upon rise or fall to complete the lifting operation so as to achieve the wireless charging operation on the desk board, thus the lifting desk is also more convenient to use and has improved practical performance.

### BRIEF DESCRIPTION OF THE DRAWINGS

FIG. 1 is a schematic view (I) of the overall structure of Embodiment 1;

FIG. 2 is a schematic view (II) of the overall structure of Embodiment 1;

FIG. 3 is a schematic view (III) of the overall structure of Embodiment 1;

FIG. 4 is an exploded view of Embodiment 1;

FIG. 5 is a schematic structural view (I) of a drawer of Embodiment 1;

FIG. 6 is a schematic structural view (II) of the drawer of Embodiment 1;

FIG. 7 is a schematic view (IV) of the overall structure of Embodiment 1; and

FIG. 8 is a schematic view (V) of the overall structure of Embodiment 1.

### DETAILED DESCRIPTION OF THE INVENTION

The technical solutions in the embodiments of the invention will be clearly and completely described below in conjunction with the drawings in the embodiments of the invention. It is apparent that the described embodiments are only part of rather than all of the embodiments in the invention. Based on the embodiments of the invention, all other embodiments obtained by the ordinary persons skilled in the art belong to the protection scope of the invention.

### Embodiment 1

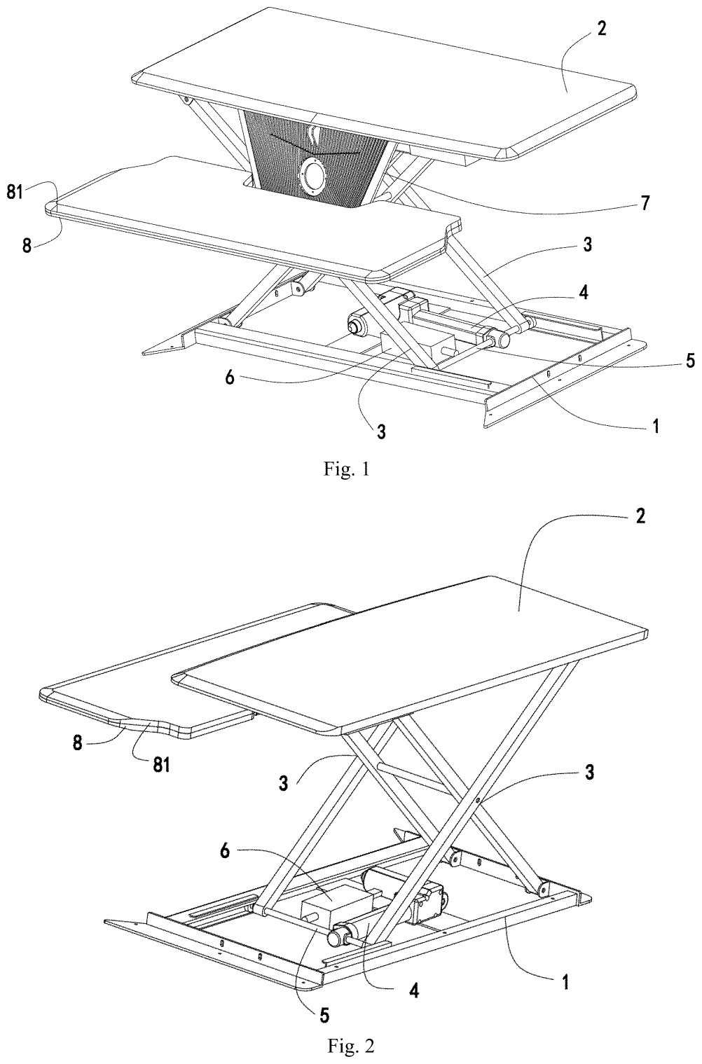

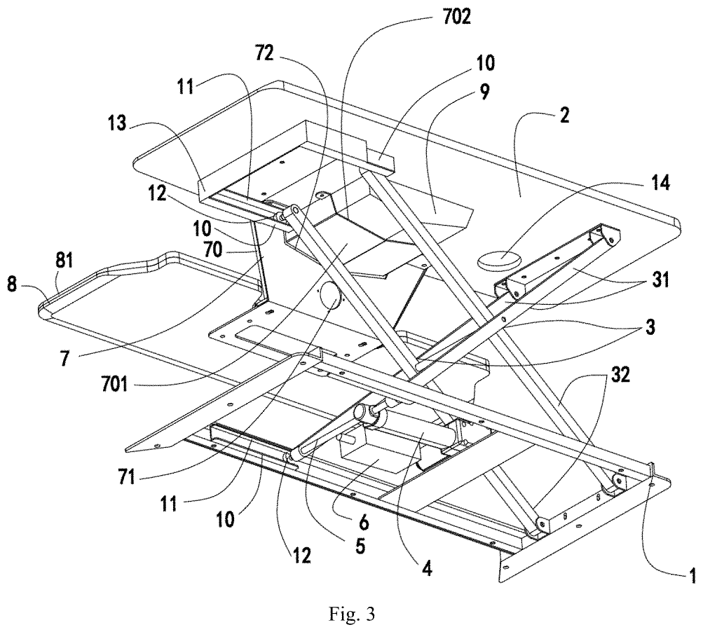

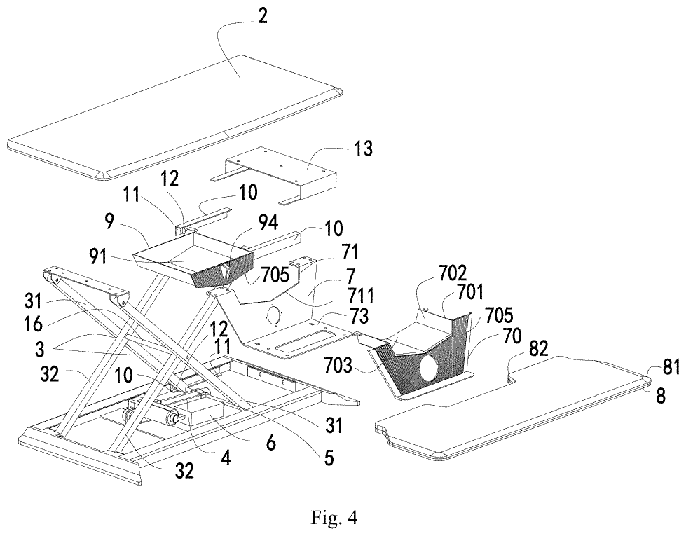

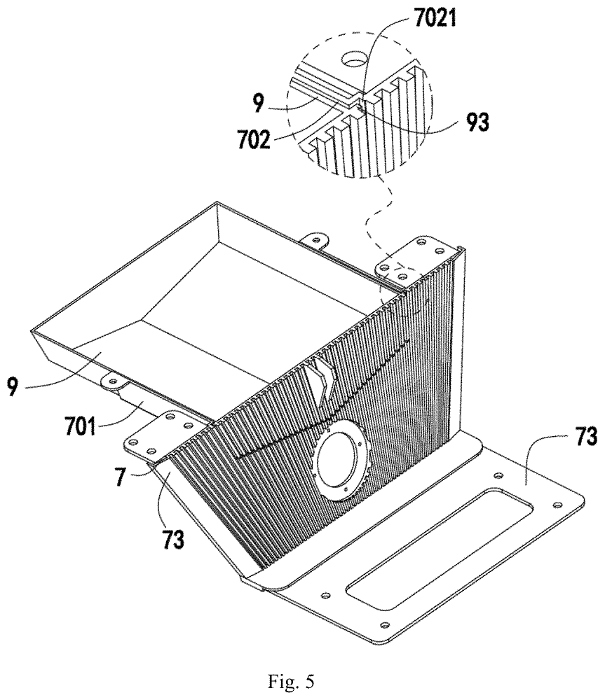

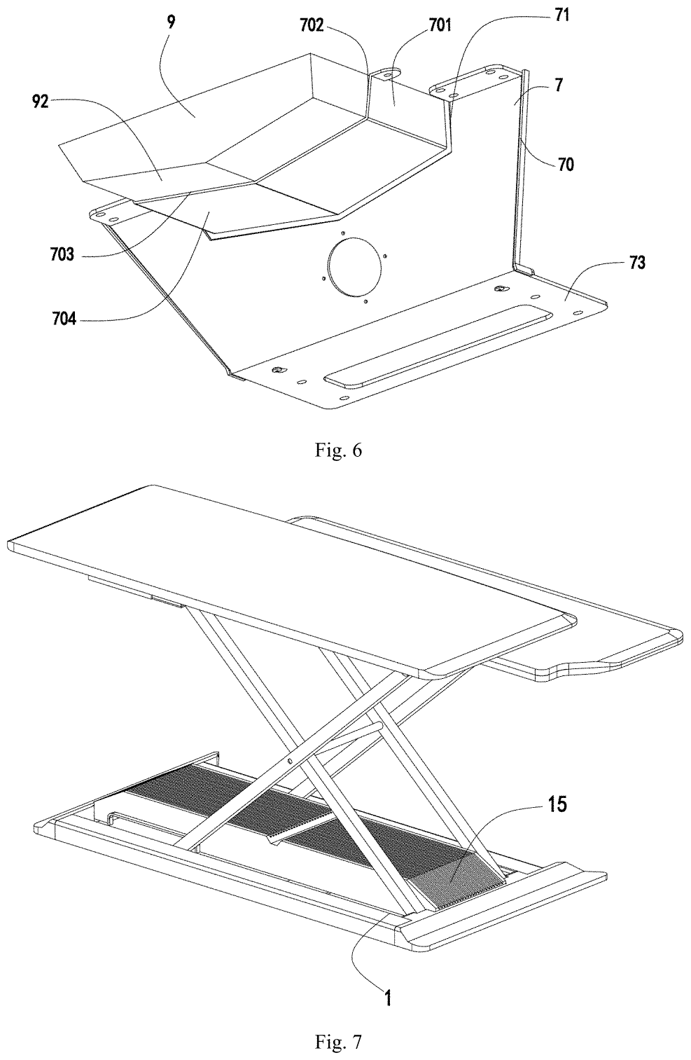

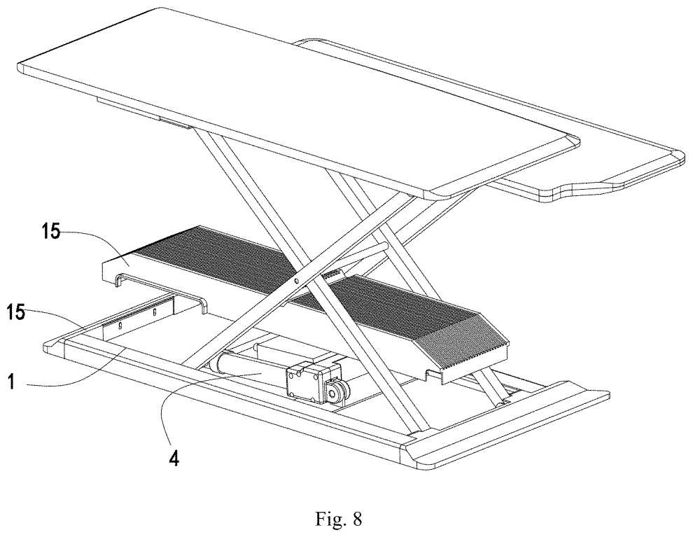

As shown in FIGS. 1 to 8, a lifting desk described in this embodiment comprises a base 1, a desk board 2, and at least two fork-type lifting frames 3 which are located between the base 1 and the desk board 2 and spacedly arranged in parallel, wherein respective one ends of the bottom of the at least two fork-type lifting frames 3 are translationally hinged with one side portion of the base, and respective one ends of the top of the lifting frames are translationally hinged with one side portion of a bottom surface of the desk board 2; the other respective ends of the bottom of the at least two fork-type lifting frames 3 are hinged with the other side portion of the base via pins, and the other respective ends of the top of the lifting frames are hinged with the other side portion of the desk board 2 via pins; the respective one ends of the bottom of the at least two fork-type lifting frames 3 are connected to each other by a connecting rod 5, a driving device 4 for controlling the rise or fall of the fork-type lifting frames 3 is fixed on the base 1, and the driving device 4 is fixedly connected with the connecting rod 5; and a limit sensor 6 is mounted on a side portion of the driving device 4, and a probe of the limit sensor 6 is corresponding to the connecting rod 5. The driving device may be a linear lifting electric cylinder, an air cylinder, an oil cylinder or a gas spring. The linear lifting electric cylinder is composed of a cylinder body, and a screw rod and a servo motor disposed in the cylinder body, wherein a piston rod extends out of an end of the cylinder body, and a bottom end of the piston rod is fixed to a roller slider of the screw rod.

A wireless charging device 14 is embedded in the desk board 2. The wireless charging device solves the technical problems in the prior art that, a charging data line must be pulled out from a power plug and plugged into a mobile phone or a tablet personal computer for charging operation when the mobile phone or the tablet personal computer needs to be charged, it is inconvenient to answer an incoming call, make a phone call, and view and reply messages during charging due to the limited length of the charging data line, and the charging data line is easily entangled with other power lines, keyboard connecting lines or mouse connecting lines such that the desktop of the lifting desk is quite messy, thereby achieving the technical effects of convenient charging, and a clean and tidy desktop during charging, and avoiding answering a phone call or playing games during charging (since operations such as answering a phone call or playing games during charging make it easy to get a lithium battery hot, a safety accident is easily caused due to the hot battery, which leads to lower safety).

The design principle of the above structure is as follows: the linear lifting electric cylinder and the limit sensor are powered on to work, and a piston rod of the linear lifting electric cylinder extends out such that upper and lower ends of the fork-type lifting frames are expanded to perform the operation of lowering the fork-type lifting frames; the piston rod of the linear lifting electric cylinder is retracted to facilitate the retraction of the upper and lower ends of the fork-type lifting frames to perform the operation of raising the fork-type lifting frames, the lifting frames are raised until the connecting rod contacts the probe of the limit sensor, and then the electric cylinder is automatically powered off to stop working, thus completing the rise to the maximum limit; and the individual fork-type lifting frames are spacedly arranged front and rear in parallel such that the desk board is more stably and reliably supported to prevent rollover. The mobile phone or the tablet personal computer is wirelessly charged by the wireless charging device

In this embodiment, respective one ends of the bottom of the at least two fork-type lifting frames 3 are translationally hinged with one side portion of the base 1, and respective one ends of the top of the lifting frames are translationally hinged with one side portion of a bottom surface of the desk board 2; and the specific translational hinging is configured as follows: each of the at least two fork-type lifting frames 3 comprises one supporting rod I 31 and one supporting rod II 32 which are hinged via pins after intersecting with each other, two tracks 10 are respectively arranged on the bottom surface of the desk board 2 and the base 1, and the tracks 10 on the desk board 2 are positioned correspondingly to the tracks 10 on the base 1; translational grooves 11 of the tracks 10 are internally provided with translatable pulleys 12, bottom ends of the at least two supporting rods I 31 are translationally hinged with the pulleys on the base 1 via rotating shafts, and top ends of the supporting rods I are hinged with the bottom surface of the desk board 2 via pins; top ends of the at least two supporting rods II 32 are translationally hinged with the pulleys on the bottom surface of the desk board 2 via rotating shafts, and bottom ends of the supporting rods II are hinged with a side portion of the base 1 via pins; the bottom ends of the at least two supporting rods I 31 are connected to each other by the connecting rod 5; and hinged points of the at least two supporting rods II 32 are fixedly connected to each other by a cross bar 16. This structure allows that when the fork-type lifting frames rise or fall, the parts above or below hinged points between the supporting rods I and the supporting rods II are more smoothly and stably expanded or retracted, thus improving the service performance and providing a more compact structure; and the two supporting rods II are fixed by the cross bar such that the two supporting rods II are more firmly positioned. Moreover, the pulleys can be slided or translated or rolled in the translational grooves of the tracks.

In this embodiment, a vertically penetrating mounting housing 13 is fixed on the bottom surface of the desk board 2, and the two tracks 10 on the desk board 2 are respectively mounted and positioned on left and right inner side walls of the mounting housing 13. This structure allows that the tracks are more firmly and conveniently mounted and positioned, and the pulleys also slide more smoothly in the translational grooves.

In this embodiment, the lifting desk further comprises a keyboard supporting board 8, wherein a front side portion of the desk board 2 is fixedly connected with the keyboard supporting board 8 by an inclined connection board 7. The keyboard supporting board thereof is used for supporting a keyboard. When the keyboard supporting board is fixed, a positioning groove is arranged at a rear side of the keyboard supporting board, the inclined connection board is inserted into the positioning groove, a supporting board is arranged at the bottom of the inclined connection board, and a bottom surface of the rear side of the keyboard supporting board is fixed on the supporting board. The use of the fixed structure of the keyboard supporting board allows the keyboard supporting board to be more firmly and reliably fixed.

In this embodiment, the inclined connection board 7 is provided with a USB interface 71 and a drawer slot 702, a drawer box 9 is inserted into the drawer slot 702, a top edge of the drawer slot 702 is fixedly connected with the bottom surface of the desk board 2, and a handle 94 is arranged on a front side face of the drawer box 9. A data line can be directly plugged into the USB interface to charge any mobile device, without the additional need to plug a plug into a power socket, thus providing more convenience in use. The drawer box has the function of storing articles.

In this embodiment, the drawer slot 702 is specifically configured as follows: a through hole 72 is arranged at the top of the inclined connection board 7, and a decorative board 70 is fixed on a front side face of the inclined connection board; a drawer slot body 701 is arranged at the top of the decorative board 70, the drawer slot body 701 penetrates through the through hole 72, an inner side face of the bottom of the drawer slot 702 on the drawer slot body 701 and a bottom side face in the drawer box 9 are respectively recessed downward in the shape of an isosceles triangle to form an inwardly inclined recessed portion I 91, and an outer side face of the bottom of the drawer slot body 701 forms an isosceles-triangle outer side face I 704 which is identical to the recessed shape of an isosceles triangle after the fork-type lifting frames 3 are fully unfolded; an outer side face of the bottom of the drawer box 9 forms an isosceles-triangle outer side face II 92 correspondingly matching the inwardly inclined recessed portion I 91; an inwardly inclined recessed portion II 711 that matches the isosceles-triangle outer side face I 704 in a fitting manner is arranged on a bottom side face of the through hole 72; and decorative stripes 705 are respectively arranged on a front side face of the decorative board 70 and a front side face of the drawer box 9. This structure is compact and reliable, the isosceles-triangle outer side faces and the inwardly inclined portions allow that the drawer box has a larger inner space, and the fork-type supporting frames just fit on an outside bottom surface of the drawer slot body after being fully unfolded, thus ensuring that no interference occurs after the desk board is lowered. Positioning boards are respectively arranged at two sides and a bottom side of the decorative board, positioning blocks are arranged at two sides of the bottom-side positioning board, the inclined connection board is positioned between the positioning boards at the two sides of the decorative board, the bottom-side positioning board butts against a top surface of the supporting board of the inclined connection board, the supporting board is positioned between the positioning blocks at the two sides of the bottom-side positioning board, and the components are fixed by bolts after positioning is completed.

In this embodiment, a shield shell 15 is covered above the driving device 4 and at the side portion of the base 1. The shield shell has a dust-proof effect and makes the base more aesthetic.

In this embodiment, an existing flange 93 is arranged on a side edge of the front side face of the drawer box 9, an existing annular groove 7021 is arranged at a front-end opening of the drawer slot 702, and the flange 93 is correspondingly inserted into the annular groove 7021. This structure is used for positioning the retracted drawer box to prevent the drawer from being pushed too much into the drawer slot, which makes it more difficult to pull out the drawer box, thereby improving the service performance.

In this embodiment, an anti-skid cushion 91 is fixed on a top surface of the keyboard supporting board 8 in a fitting manner; and the anti-skid cushion can prevent articles placed on the keyboard supporting board from sliding down.

The invention is not limited to the above most preferred embodiment, and various other forms of products can be obtained by any person under the inspiration of the invention. However, regardless of any change to its shape or structure, any technical solution which is the same as or similar to the present application shall fall into the protection scope of the invention.

1. A lifting desk, comprising a base, a desk board and a lifting mechanism mounted between the base and the desk board, a wireless charging device being embedded in the desk board; the lifting mechanism comprising at least two lifting frames, respective one ends of the bottom of the at least two fork-type lifting frames being translationally hinged with one side portion of the base, and respective one ends of the top of the lifting frames being translationally hinged with one side portion of a bottom surface of the desk board; the other respective ends of the bottom of the at least two fork-type lifting frames being hinged with the other side portion of the base via pins, and the other respective ends of the top of the lifting frames being hinged with the other side portion of the desk board via pins; and the respective one ends of the bottom of the at least two fork-type lifting frames being connected to each other by a connecting rod, a driving device for controlling the rise or fall of the fork-type lifting frames being fixed on the base, and the driving device being fixedly connected with the connecting rod.

2. The lifting desk according to claim 1, further comprising a keyboard supporting board, a front side portion of the desk board being fixedly connected with the keyboard supporting board by an inclined connection board.

3. The lifting desk according to claim 2, wherein the inclined connection board is provided with a USB interface and a drawer slot, a drawer box is inserted into the drawer slot, a top edge of the drawer slot is fixedly connected with the bottom surface of the desk board, and a handle is arranged on a front side face of the drawer box.

4. The lifting desk according to claim 3, wherein the drawer slot is specifically configured as follows: a through hole is arranged at the top of the inclined connection board, and a decorative board is fixed on a front side face of the inclined connection board; a drawer slot body is arranged at the top of the decorative board, the drawer slot body penetrates through the through hole, an inner side face of the bottom of the drawer slot on the drawer slot body and a bottom side face in the drawer box are respectively recessed downward in the shape of an isosceles triangle to form an inwardly inclined recessed portion I, and an outer side face of the bottom of the drawer slot body forms an isosceles-triangle outer side face I which is identical to the recessed shape of an isosceles triangle after the fork-type lifting frames are fully unfolded; an outer side face of the bottom of the drawer box forms an isosceles-triangle outer side face II correspondingly matching the inwardly inclined recessed portion I; an inwardly inclined recessed portion II that matches the isosceles-triangle outer side face I in a fitting manner is arranged on a bottom side face of the through hole; and decorative stripes are respectively arranged on a front side face of the decorative board and a front side face of the drawer box.

5. The lifting desk according to claim 3, wherein an existing flange is arranged on a side edge of the front side face of the drawer box, an existing annular groove is arranged at a front-end opening of the drawer slot, and the flange is correspondingly inserted into the annular groove.

6. The lifting desk according to claim 2, wherein an anti-skid cushion is fixed on a top surface of the keyboard supporting board in a fitting manner.

7. The lifting desk according to claim 1, wherein respective one ends of the bottom of the at least two fork-type lifting frames are translationally hinged with one side portion of the base, and respective one ends of the top of the lifting frames are translationally hinged with one side portion of a bottom surface of the desk board; and the specific translational hinging is configured as follows: each of the at least two fork-type lifting frames comprises one supporting rod I and one supporting rod II which are hinged via pins after intersecting with each other, two tracks are respectively arranged on the bottom surface of the desk board and the base, and the tracks on the desk board are positioned correspondingly to the tracks on the base; translational grooves of the tracks are internally provided with translatable pulleys, bottom ends of the at least two supporting rods I are translationally hinged with the pulleys on the base via rotating shafts, and top ends of the supporting rods I are hinged with the bottom surface of the desk board via pins; top ends of the at least two supporting rods II are translationally hinged with the pulleys on the bottom surface of the desk board via rotating shafts, and bottom ends of the supporting rods II are hinged with a side portion of the base via pins; the bottom ends of the at least two supporting rods I are connected to each other by the connecting rod; and hinged points of the at least two supporting rods II are fixedly connected to each other by a cross bar.

8. The lifting desk according to claim 7, wherein a vertically penetrating mounting housing is fixed on the bottom surface of the desk board, and the two tracks on the desk board are respectively mounted and positioned on left and right inner side walls of the mounting housing.

9. The lifting desk according to claim 1, wherein a limit sensor is mounted on a side portion of the driving device, and a probe of the limit sensor is corresponding to the connecting rod.

10. The lifting desk according to claim 9, wherein a shield shell is covered above the driving device and at the side portion of the base, and the driving device is a linear lifting electric cylinder.
